(19) United States
(12) Patent Application Publication
(10) Pub. No.: US 2024/0357949 A1
(43) Pub. Date: Oct. 31, 2024

(54) Spade Shovel Device

(71) Applicants: Leif Larrimore, Dallas, GA (US); Barbara Lynn Jones, Dallas, GA (US)

(72) Inventors: Leif Larrimore, Dallas, GA (US); Barbara Lynn Jones, Dallas, GA (US)

(21) Appl. No.: 18/447,719

(22) Filed: Aug. 10, 2023

Related U.S. Application Data
(60) Provisional application No. 63/461,926, filed on Apr. 26, 2023.

(51) Int. Cl. A01B 1/02; A01B 1/22

(52) U.S. Cl. CPC A01B 1/02; A01B 1/227

(57) ABSTRACT

A spade shovel device is provided. The device is comprised of a shaft and a blade, wherein the blade may be comprised of a first cutting edge and a second cutting edge that may form an acute, right, or obtuse angle. The edges may be comprised of a blade edge or a serrated edge to easily cut through roots and penetrate a ground surface. Further, the shape of the edges allow the device to easily dig around a fence post.

### CROSS-REFERENCE TO RELATED APPLICATION

The present application claims priority to, and the benefit of, U.S. Provisional Application No. 63/461,926, which was filed on Apr. 26, 2023, and is incorporated herein by reference in its entirety.

### FIELD OF THE INVENTION

The present invention relates generally to the field of tools. More specifically, the present invention relates to a spade shovel device with a first and second cutting edge that allows a user to easily cut through roots and around posts while digging. Accordingly, the present disclosure makes specific reference thereto. Nonetheless, it is to be appreciated that aspects of the present invention are also equally applicable to other like applications, devices, and methods of manufacture.

### BACKGROUND

In various landscaping, gardening, and construction activities, digging through soil near tree roots, poles, fence posts, and similar obstructions is a common and essential task. However, this process often poses significant challenges when using conventional shovels. More specifically, even while using substantial force exerted during digging, a traditional shovel may be unable to break through roots (or a hard ground surface), causing frustration and inefficiency in the digging process. Moreover, the design of conventional shovels typically includes a center section that can become an obstacle when trying to dig around poles or fence posts. As a result, users are often compelled to adopt awkward and uncomfortable positions while digging to accommodate the limitations of the standard shovel's design.

Therefore, there exists a long-felt need in the art for an improved shovel. There also exists a long-felt need in the art for a spade shovel device. More specifically, there exists a long-felt need in the art for a spade shovel device that can be used to easily cut roots while digging. In addition, there exists a long-felt need in the art for a spade shovel device that be used to penetrate a hard ground surface. Further, there exists a long-felt need in the art for a spade shovel device that can be used to easily dig around a fence post or other similar object.

The subject matter disclosed and claimed herein, in one embodiment thereof, comprises a spade shovel device. The device is comprised of a shaft and a blade. The blade may be comprised of a first cutting edge and a second cutting edge that may form an acute, right, or obtuse angle. The edges may be comprised of a blade edge or a serrated edge to easily cut through roots and penetrate a ground surface. Further, the shape of the edges allow the device to easily dig around a fence post. In one embodiment, the perimeter edges of the device may also be comprised of a blade or serrated edge.

In this manner, the spade shovel device of the present invention accomplishes all the forgoing objectives and provides an improved shovel that can be used to easily cut roots while digging. In addition, the device can be used to penetrate a hard ground surface. Further, the device can be used to easily dig around a fence post or other similar object.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spade shovel device. The device is comprised of a handle, a shaft, and a blade. The device is designed to be used as a traditional shovel, while also allowing a user to utilize a first cutting edge and a second cutting edge to cut through roots, dig around fence posts, etc.

The handle may be parallel or perpendicular to the shaft in different embodiments. In one embodiment, the handle is comprised of at least one grip area. In one embodiment, the handle may circumferentially wrap around the shaft. In another embodiment, the handle is comprised of an opening such that a user can place their hand through/around the handle during use.

The device is also comprised of a shaft. At least one blade attaches to the shaft via a collar. The blade may be a plurality of different shovel blade types in different embodiments. In one embodiment, the collar allows the blade to removably attach to the shaft via at least one fastener such as but not limited to a set screw. The fastener may be received by at least one reciprocating fastener of the shaft, such as but not limited to a threaded opening. This allows a user to remove a blade of a first style and attach a blade of a second style to the shaft.

The blade is preferably comprised of a first cutting edge and a second cutting edge. The edges may form an acute, right, or obtuse angle at the tip of the blade. As a result, the edges form a cutting structure that can be used to cut roots and easily break through a ground surface. In one embodiment, the edges are comprised of a blade edge. In another embodiment, the edges are comprised of a serrated-tooth blade edge.

The present invention is also comprised of a method of using the device. First, a device is provided comprised of a shaft and a blade that attaches to the shaft, the blade comprised of a first cutting edge and a second cutting edge that form an acute, right, or obtuse angle. Then, a user can use the blade to dig into a ground surface while stepping downwards on at least one step of the blade and also while also using the cutting edges to cut any roots in the ground surface. The cutting edges can also be used to dig around a post or other object embedded within the ground.

The present invention is also comprised of a second method of using the device. First, a device is provided comprised of a shaft and a blade that attaches to the shaft, the blade comprised of a first cutting edge and a second cutting edge that form an acute, right, or obtuse. Then, a user can attach the blade to the shaft using a fastener on a collar of the blade and a fastener on the shaft. Then, a user can use the blade to dig into a ground surface while stepping downwards on at least one step of the blade and while also using the cutting edges cut any roots in the ground surface. The cutting edges can also be used to dig around a post or other object embedded within the ground.

Accordingly, the spade shovel device of the present invention is particularly advantageous as it provides an improved shovel that can be used to easily cut roots while digging. In addition, the device can be used to penetrate a hard ground surface and can be used to easily dig around a fence post or other similar object. In this manner, the spade shovel device overcomes the limitations of existing shovels known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a spade shovel device of the present invention in accordance with the disclosed architecture;

FIG. 2 illustrates an enhanced perspective view of a blade of one potential embodiment of a spade shovel device of the present invention in accordance with the disclosed architecture;

FIG. 3 illustrates a flowchart of a method of using one potential embodiment of a spade shovel device of the present invention in accordance with the disclosed architecture; and

FIG. 4 illustrates a flowchart of a method of using one potential embodiment of a spade shovel device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved shovel. There also exists a long-felt need in the art for a spade shovel device. More specifically, there exists a long-felt need in the art for a spade shovel device that can be used to easily cut roots while digging. In addition, there exists a long-felt need in the art for a spade shovel device that be used to penetrate a hard ground surface. Further, there exists a long-felt need in the art for a spade shovel device that can be used to easily dig around a fence post or other similar object.

The present invention, in one exemplary embodiment, is comprised of a spade shovel device. The device is comprised of a handle, a shaft, and a blade. The device is designed to be used as a traditional shovel, while also allowing a user to utilize a first cutting edge and a second cutting edge to cut through roots, dig around fence posts, etc.

The handle may be parallel or perpendicular to the shaft in different embodiments. In one embodiment, the handle is comprised of at least one grip area. In one embodiment, the handle may circumferentially wrap around the shaft. In another embodiment, the handle is comprised of an opening such that a user can place their hand through/around the handle during use.

The device is also comprised of a shaft, wherein at least one blade attaches to the shaft via a collar. The blade may be a plurality of different shovel blade types in different embodiments. In one embodiment, the collar allows the blade to removably attach to the shaft via at least one fastener such as but not limited to a set screw. The fastener may be received by at least one reciprocating fastener of the shaft, such as but not limited to a threaded opening. This allows a user to remove a blade of a first style and attach a blade of a second style to the shaft.

The blade is preferably comprised of a first cutting edge and a second cutting edge. The edges may form an acute, right, or obtuse angle at the tip of the blade to form a cutting structure. The structure can be used to cut roots and easily break through a ground surface. In one embodiment, the edges are comprised of a blade edge. In another embodiment, the edges are comprised of a serrated-tooth blade edge.

The present invention is also comprised of a method of using the device. First, a device is provided comprised of a shaft and a blade that attaches to the shaft, the blade comprised of a first cutting edge and a second cutting edge that form an acute, right, or obtuse angle. Then, a user can use the blade to dig into a ground surface while stepping downwards on at least one step of the blade and also while also using the cutting edges to cut any roots in the ground surface. The cutting edges can also be used to dig around a post or other object embedded within the ground.

The present invention is also comprised of a second method of using the device. First, a device is provided comprised of a shaft and a blade that attaches to the shaft, the blade comprised of a first cutting edge and a second cutting edge that form an acute, right, or obtuse. Then, a user can attach the blade to the shaft using a fastener on a collar of the blade and a fastener on the shaft. Then, a user can use the blade to dig into a ground surface while stepping downwards on at least one step of the blade and while also using the cutting edges cut any roots in the ground surface. The cutting edges can also be used to dig around a post or other object embedded within the ground.

Accordingly, the spade shovel device of the present invention is particularly advantageous as it provides an improved shovel that can be used to easily cut roots while digging. In addition, the device can be used to penetrate a hard ground surface and can be used to easily dig around a fence post or other similar object. In this manner, the spade shovel device overcomes the limitations of existing shovels known in the art.

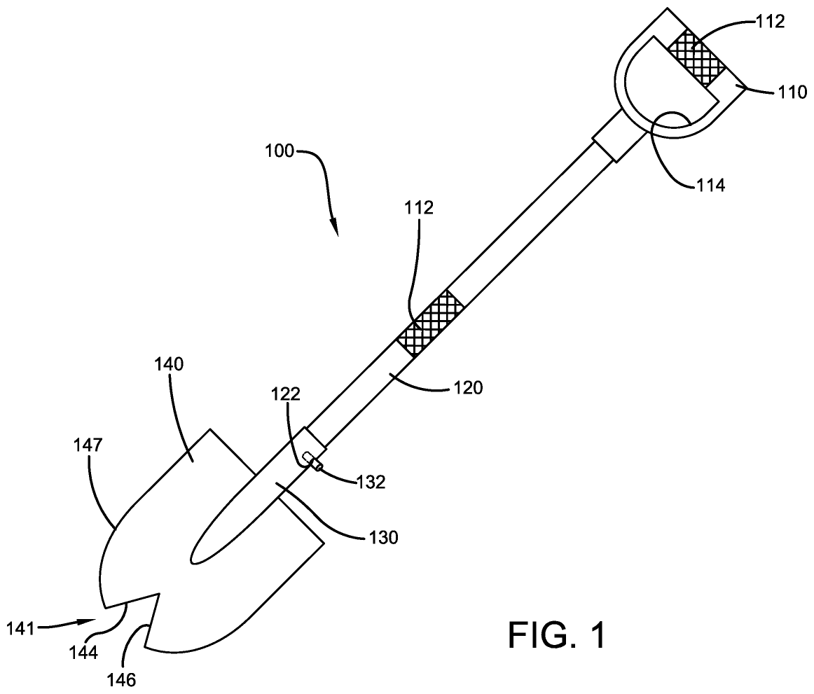

Referring initially to the drawings, FIG. 1 illustrates a perspective view of one potential embodiment of a spade shovel device 100 of the present invention in accordance with the disclosed architecture. The device 100 is comprised of a handle 110, a shaft 120, and a blade 140. The device is designed to be used as a traditional shovel, while also allowing a user to utilize a first cutting edge 144, and in one embodiment a second cutting edge 146, to cut through roots, dig around fence posts, etc.

The handle 110 may be parallel or perpendicular to the shaft 120 in different embodiments. In one embodiment, the handle 110 is comprised of at least one grip area 112. The grip area 112 may be comprised of a non-slip material such as but not limited to rubber. The grip area 112 may be comprised of a raised or recessed texture to improve grip. In one embodiment, a second grip area 112 may also be positioned around a portion of the shaft 120 to provide a second gripping area.

In one embodiment, the handle 110 may circumferentially wrap around the shaft 120. In another embodiment, the handle 110 is comprised of an opening 114 such that a user can place their hand through/around the handle 110 during use. In either embodiment, the handle 110 may be comprised of a contoured handle to fit the fingers/hand of a user.

The device 100 is also comprised of a shaft 120. The shaft 120 is preferably made of a wood material, but may also be made of lightweight metal, or any other material known in the art. At least one blade 140 attaches to the shaft 120. More specifically, the blade has at least one collar 130 which attaches to the shaft 120. The collar 130 may be any type of shovel blade 140 attachment method and construction known in the art.

The blade 140 may be a plurality of different shovel blade types in different embodiments. Said types include but are not limited to an edging shovel, a trench shovel, a flat shovel, a tree-planting shovel, a power shovel, a post hole shovel, a handheld shovel, a scoop shovel, a pointed digger shovel, etc. In one embodiment, the collar 130 allows the blade 140 to removably attach to the shaft 120 via at least one fastener 132 such as but not limited to a set screw. The fastener 132 may be received by at least one reciprocating fastener 122 of the shaft 120, such as but not limited to a threaded opening. This allows a user to remove a blade 140 of a first style and attach a blade 140 of a second style to the shaft 120. As a result, a user can optimize the blade 140 style used for the specific cutting application.

The blade 140 may be comprised of at least one step 142. The step 142 provides a flat surface for a user to step downwards onto the blade 140 to drive the blade 140 into the ground during use. The step 142 is preferably rectangular, but may be any shape.

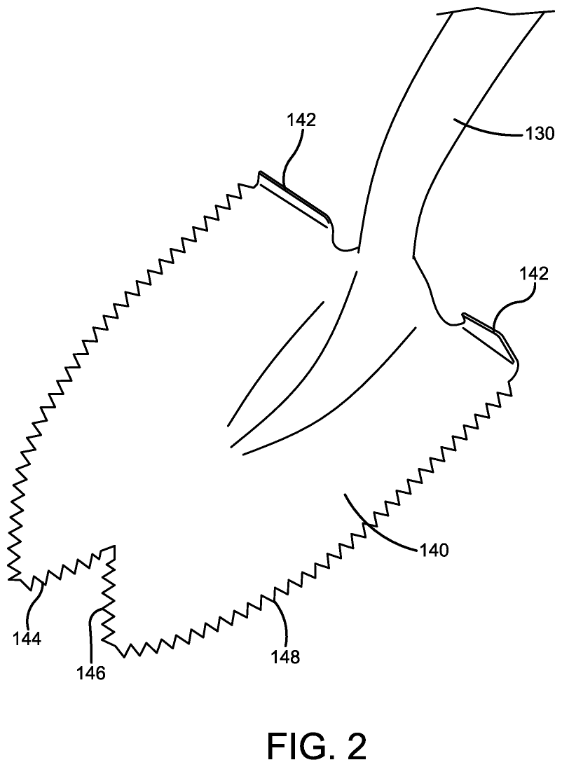

The blade 140 is comprised of at least a first cutting edge 144, but preferably a first cutting edge 144 and a second cutting edge 146. The edges 144, 146 may form an acute, right, or obtuse angle at the tip 141 of the blade 140. As a result, the edges 144, 146 form a cutting structure that can be used to cut roots and easily break through a ground surface. In one embodiment, the edges 144, 146 are comprised of a blade edge. In another embodiment, the edges 144, 146 are comprised of a serrated-tooth blade edge, as seen in FIG. 2. Similarly, the perimeter edge 147 of the blade 140 may be comprised of a blade edge or a serrated-tooth blade edge (as seen in FIG. 2). In this manner, but the cutting edges 144, 146 and perimeter edge 147 can be used to cut roots during digging.

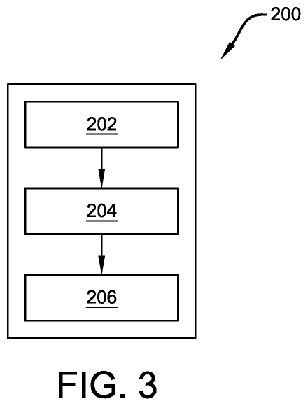

The present invention is also comprised of a method of using 200 the device 100, as seen in FIG. 3. First, a device 100 is provided comprised of a shaft 120 and a blade 140 that attaches to the shaft 120, the blade comprised of a first cutting edge 144 and a second cutting edge 146 that form an acute, right, or obtuse angle [Step 202]. Then, a user can use the blade 140 to dig into a ground surface while stepping downwards on at least one step 142 of the blade 140 and also while also using the cutting edges 144, 146 to cut any roots in the ground surface [Step 204]. The cutting edges 144, 146 can also be used to dig around a post or other object embedded within the ground [Step 206].

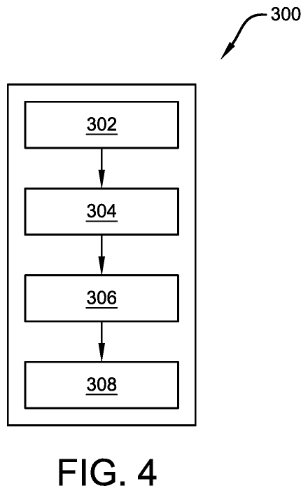

The present invention is also comprised of a second method of using 300 the device 100, as seen in FIG. 4. First, a device 100 is provided comprised of a shaft 120 and a blade 140 that attaches to the shaft 120, the blade comprised of a first cutting edge 144 and a second cutting edge 146 that form an acute, right, or obtuse angle [Step 302]. Then, a user can attach the blade 140 to the shaft 120 using a fastener 132 on a collar 130 of the blade 140 and a fastener 122 on the shaft 120 [Step 304]. Then, a user can use the blade 140 to dig into a ground surface while stepping downwards on at least one step 142 of the blade 140 and while also using the cutting edges 144, 146 to cut any roots in the ground surface [Step 306]. The cutting edges 144, 146 can also be used to dig around a post or other object embedded within the ground [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spade shovel device” and “device” are interchangeable and refer to the spade shovel device 100 of the present invention.

Notwithstanding the forgoing, the spade shovel device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the spade shovel device 100 as shown in the FIGS. are for illustrative purposes only, and that many other sizes and shapes of the spade shovel device 100 are well within the scope of the present disclosure. Although the dimensions of the spade shovel device 100 are important design parameters for user convenience, the spade shovel device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spade shovel device comprising:
a shaft comprised of a handle; and
a blade comprised of a first cutting edge, a second cutting edge, and a collar.

2. A spade shovel device of claim 1, wherein the blade is comprised of an edging shovel, a trench shovel, a flat shovel, a tree-planting shovel, a power shovel, a post hole shovel, a handheld shovel, a scoop shovel, or a pointed digger shovel.

3. A spade shovel device of claim 1, wherein the first cutting edge and the second cutting edge form an acute angle.

4. A spade shovel device of claim 1, wherein the first cutting edge and the second cutting edge form a right angle.

5. A spade shovel device of claim 1, wherein the first cutting edge and the second cutting edge form an obtuse angle.

6. A spade shovel device of claim 1, wherein the collar removably attaches to the shaft.

7. A spade shovel device of claim 6, wherein the collar is comprised of a first fastener.

8. A spade shovel device of claim 7, wherein the first fastener is received by a second fastener of the shaft.

9. A spade shovel device of claim 7, wherein the first fastener is comprised of a set screw.

10. A spade shovel device of claim 8, wherein the second fastener is comprised of a threaded opening.

11. A spade shovel device comprising:
a shaft comprised of a first grip area, and a handle comprised of an opening and a second grip area; and
a blade comprised of a first cutting edge, a second cutting edge, and a collar.

12. A spade shovel device of claim 11, wherein the blade is comprised of an edging shovel, a trench shovel, a flat shovel, a tree-planting shovel, a power shovel, a post hole shovel, a handheld shovel, a scoop shovel, or a pointed digger shovel.

13. A spade shovel device of claim 11, wherein the first cutting edge and the second cutting edge form an acute angle, a right angle, or an obtuse angle.

14. A spade shovel device of claim 11, wherein the first cutting edge and the second cutting are comprised of a blade edge.

15. A spade shovel device of claim 11, wherein the first cutting edge and the second cutting are comprised of a serrated edge.

16. A spade shovel device of claim 11, wherein the first grip area and the second grip area are comprised of a non-slip material.

17. A spade shovel device of claim 11, wherein the first grip area and the second grip area are comprised of a raised or a recessed texture.

18. A spade shovel device of claim 11, wherein a perimeter edge of the blade is comprised of a blade edge or a serrated edge.

19. A method of using a spade shovel device, the method comprising the following steps:
providing a spade shovel device comprised of a shaft and a blade that attaches to the shaft, the blade comprised of a first cutting edge and a second cutting edge;
using the blade to dig into a ground surface; and
using the first cutting edge and the second cutting edge to cut a root.

20. A method of using a spade shovel device of claim 19 further comprised of a step of using the first cutting edge and the second cutting edge to dig around a post.
